(19) United States
(12) Patent Application Publication
(10) Pub. No.: US 2013/0214928 A1
(43) Pub. Date: Aug. 22, 2013

(54) ROCK DRILLING RIG, METHOD FOR TRANSFER DRIVE OF THE SAME, AND SPEED CONTROLLER

(71) Applicants: Jarno Kuittinen, Tampere (FI); Jukka Osara, Tampere (FI)

(72) Inventors: Jarno Kuittinen, Tampere (FI); Jukka Osara, Tampere (FI)

(73) Assignee: Sandvik Mining and Construction OY, Tampere (FI)

(21) Appl. No.: 13/699,352

(22) PCT Filed: May 24, 2011
(86) PCT No.: PCT/FI2011/050468

§ 371 Date: Mar. 12, 2013

(30) Foreign Application Priority Data
May 25, 2010 (FI) 20105579

(51) Int. Cl. B60L 15/20; B60W 30/18; B60W 50/14; E21B 7/02

(52) U.S. Cl. CPC B60L 15/20; E21B 7/025; B60W 30/18; B60W 50/14
USPC 340/669; 175/162; 175/57; 74/491

(57) ABSTRACT

The invention relates to a rock drilling rig, a method for transfer drive of the rock drilling rig, and a speed controller. The rock drilling rig includes combustion-engine-free drive equipment which includes a plurality of electric components for implementation of the transfer drive. The control unit of the rock drilling rig includes load monitoring which monitors the load of the components during the transfer drive. Load monitoring allows the electric driving system to be intentionally overloaded for a period of time limited in advance. A user interface of the control unit comprises a speed controller whose control element has a first control range, where operation takes place in the rated load range, and a second control range, where operation takes place in the overload range.

### BACKGROUND OF THE INVENTION

The invention relates to a rock drilling rig comprising a drilling boom provided with a rock drill such that drilling can be carried out thereby at selected drilling sites. The rock drilling rig also comprises a combustion-engine-free drive equipment by which it may be transferred between drilling sites. The drive equipment of the rock drilling rig comprises at least one electric motor and an electric driving system and further a control unit, which comprises means for controlling load of the electric driving system. Additionally the control unit comprises a user interface with a speed controller.

Further, the invention relates to a method for transfer drive of the rock drilling rig, and a speed controller.

The field of the invention is described in more detail in the preambles of the independent claims of the patent application.

In mines there are used rock drilling rigs, by which boreholes are drilled at planned drilling sites. When drilling of the boreholes is completed, the mining vehicle is transferred to a next drilling site for drilling a new drilling fan or face. In particular, in underground mines it is advantageous to perform the transfer drive by means of power produced by an electric motor. The energy required by the transfer drive may be stored in a battery. During the transfer drive, electric components of drive transmission become loaded and heated. Overheating may damage the component. So, the highest power in the transfer drive has to be limited typically such that the temperature in the electric components of the drive transmission will remain within allowed limits. Because of power limitations the speed of the transfer drive has to be reduced, which decreases the performance of the rock drilling rig.

### BRIEF DESCRIPTION OF THE INVENTION

The object of the present invention is to provide a new and improved rock drilling rig, a method for transfer drive of the same, and further a speed controller.

The rock drilling rig of the invention is characterized in that load monitoring is arranged to allow an intentional overload of the electric driving system according to a predetermined control strategy; and that the over-load has a limited duration, whereby overheating of the components in the electric driving system is prevented and that a control unit is arranged to indicate to the operator transfer from a rated load state to an overload state.

The method of the invention is characterized by overloading an electric driving system during transfer drive intentionally and for a period of a limited duration; and making the operator of the rock drilling rig aware of an overload situation.

The speed controller of the invention is characterized in that the speed control element comprises at least one other control range, where the control takes place in an overload portion exceeding the rated load.

The idea is that the electric driving system of the rock drilling rig may be overloaded intentionally such that it momentarily operates at a higher load than the rated load. A further idea is that the overload situation is known to the operator, for instance, such that the situation is controlled by himself/herself or it is indicated to him/her in one way or the other.

An advantage is that the rock drilling rig may be temporarily run at higher power than in the designed normal operation. Thus, the question is about a sort of power booster that is available in transfer drive such that it is possible to manage special situations of short duration, which occur therein and require a lot of power. Hence, the electric driving system of the rock drilling rig need not be designed for those driving situations requiring high power, and consequently overdesigning of components is avoided. Thus, the electric driving system may employ electric components that are less expensive and smaller in size. Further, operability and safety of the system is improved by the fact that the operator is aware of the overload situation and therefore it does not cause surprising situations.

The basic idea of an embodiment is that the electric driving system comprises an electric drive motor, which may be a permanent magnet type motor, for instance. Further, the electric driving system includes an energy storage, such as a battery or a battery package, for storing energy for transfer drive. It also includes a frequency converter, by which revolutions and torque of the drive motor may be controlled. The electric driving system may also include a voltage converter and optionally other electric components.

The basic idea of an embodiment is that load monitoring allows overload of the electric driving system, when the operator selects an over-load mode in the user interface.

The basic idea of an embodiment is that the speed controller comprises at least a first control range and a second control range. In the first control range the electric driving system may be loaded such that the rated load of the components is not exceeded. The first control range thus covers the normal state. The second control range, in turn, allows the rated load of the electric driving system components to be exceeded. The second control range thus covers an overload state. It will be easier for the operator to operate, when the load states are divided into separate control ranges. In that case, the operator will not move over to use the overload state without knowing about it.

The basic idea of an embodiment is that in the user interface of the control unit the operator is displayed the overload of the electric driving system being selected. Thanks to this application the operator is aware of an overload situation at all times.

The basic idea of an embodiment is that in the user interface the operator is displayed load monitoring information of the electric driving system, such as duration of overload situation, time left for overload situation, increase in performance provided by overload, increase in torque provided by overload and temperature of the most critical component in the electric driving system.

The basic idea of an embodiment is that the rock drilling rig comprises at least one cooling system, by which one or more electric components of the electric driving system are cooled. The control system may increase cooling of one or more components, when transition to an overload mode takes place. The cooling system may be a liquid cooling system, in which electric components are cooled with a cooling liquid. The cooling system may also be switched on in advance, when it is known that an overload situation will arise. Further, it is also possible to prepare for forthcoming overload by enhancing the cooling of one or more critical components in advance. By means of cooling the temperature in the components may be kept better under control in an overload situation, thanks to which the duration of the overload may be prolonged.

The basic idea of an embodiment is that the control unit automatically switches on an overload mode, in case a power request from the operator requires that. The control unit monitors power requests provided by a speed controller or a corresponding control element and assesses on the basis thereof, whether the power request is in compliance with the rated load, or whether there is a need to transfer to the overload mode. The control unit indicates the transfer from the rated load mode to the overload mode to the operator, whereby the operator becomes aware of the change.

The basic idea of an embodiment is to allow an overload situation only if the operator has deliberately accepted it. In that case the operator will never use the apparatus accidentally in overload mode.

The basic idea of an embodiment is that the electric driving system comprises at least one temperature sensor for monitoring the temperature of at least one critical component of the electric driving system. The load monitoring considers the temperature information when determining the allowed duration of the overload state.

The basic idea of an embodiment is that the load monitoring is arranged to discontinue overload mode, when one or more of the following predetermined limits has been reached: the maximum temperature set for one or more of the critical components of the electric driving system; the maximum temperature set for any one component of the electric driving system; the maximum duration calculated for the overload state. In this embodiment the control unit takes care that the overload will not cause damage to the components of the electric driving system. Thanks to the automatic monitoring the operator's responsibility and mental stress will reduce in the transfer drive.

The basic idea of an embodiment is that the load monitoring is arranged to notify the operator in advance prior to discontinuation of over-load state. In that case the operator may prepare himself for the extra power booster employed to be discontinued. Thus, it is possible to avoid dangerous situations caused by sudden power reductions, for instance.

The basic idea of an embodiment is to allow overload of the electric driving system in any one of the following transfer drive situations, where a lot of torque and electric power are required: drive over an obstacle; acceleration to base speed of transfer drive; steep uphill drive; drive over a pothole; drive onto a transportation platform; downhill drive of long duration.

The basic idea of an embodiment is that a speed control element included in the speed controller comprises at least a first control range and a second control range. In the second control range, the movement of the control element has a response that differs from the movement response of the first control range. The manoeuvring of the control element in the second control range may be stiffer, for instance, than manoeuvring in the normal, first movement area. Further, the scaling of the control element movement may be different in the first and the second movement areas.

The basic idea of an embodiment is that the speed controller comprises at least one detector that detects transfer to the second control range. The speed controller, the control unit or the user interface produces a sound signal, a visual message or a vibration alarm when transfer to an over-load state takes place.

The basic idea of an embodiment is that when the transfer drive is performed downhill, the electric drive motor is switched to operate as a generator. In that case the drive motor decelerates the rock drilling rig during the downhill drive and simultaneously generates electric current, which is primarily used for charging the energy storage of the rock drilling rig. Surplus electric energy generated in deceleration may be converted to thermal energy in electric brake resistors. In addition to this, by means of the surplus electric energy produced in deceleration it is possible to operate one or more hydraulic systems in the rock drilling rig, whereby all the surplus electric energy need not just be wasted through brake resistors. This improves the dynamics of the electric driving system in downhill drive. When there is one or more systems, in addition to the brake resistors, to receive surplus energy, it is possible to over-load the brake resistors momentarily during downhill drive. This application enables a kind of brake booster, which is available for a limited duration.

### BRIEF DESCRIPTION OF THE FIGURES

Some embodiments will be explained in greater detail in the attached drawings, in which

FIG. 1 shows schematically a rock drilling rig, which is transfer-driven to a drilling site for drilling,

FIG. 2 shows schematically drive equipment having an electric drive motor and provided with load monitoring and a liquid cooling system,

FIG. 3 shows schematically second drive equipment, in which an electric motor runs hydraulic driving transmission,

FIGS. 4a to 4c show schematically some speed controllers and means in connection therewith for transfer to an overload situation and detection thereof,

FIG. 5 shows by means of a simple chart details relating to transfer drive and load monitoring of drive equipment,

FIG. 6 shows schematically some transfer drive situations, in which it may be necessary to overload the electric driving system, and

FIG. 7 shows schematically, by means of a graph, the load of the electric driving system or a component thereof.

In the figures, some embodiments are shown in a simplified manner for the sake of clarity. Similar parts are denoted with the same reference numerals in the figures.

### DETAILED DESCRIPTION OF SOME EMBODIMENTS

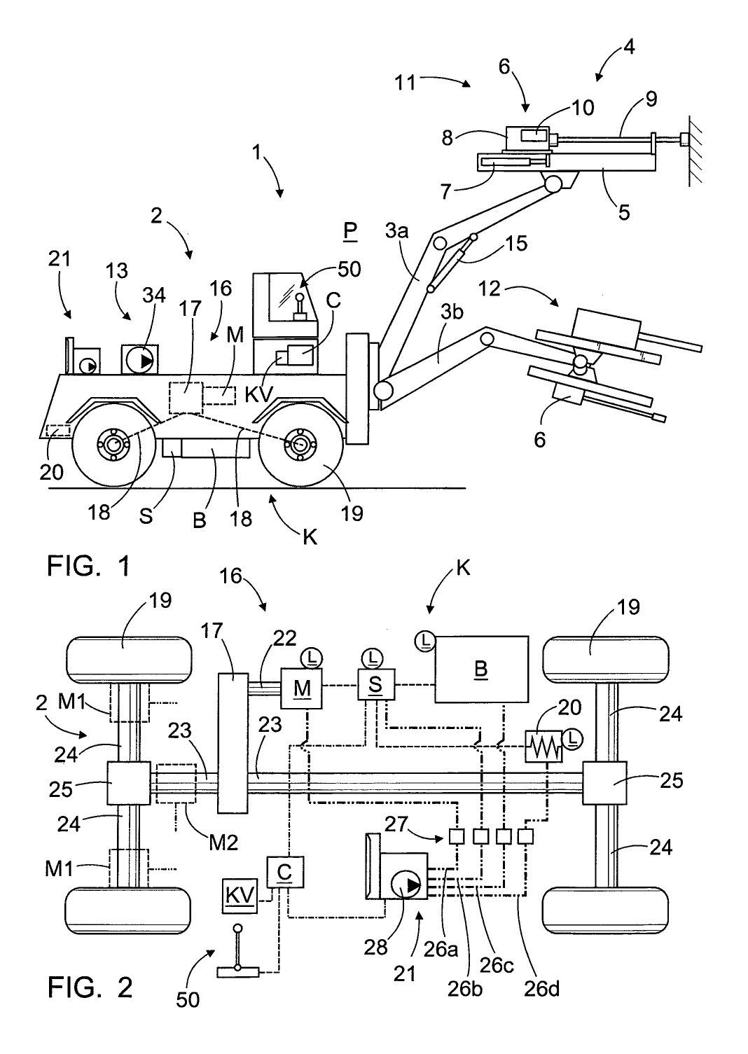

FIG. 1 shows a possible rock drilling rig 1 comprising a movable carrier 2, in which is arranged one or more drilling booms 3a, 3b equipped with a rock drilling unit 4. The drilling unit 4 may comprise a feed beam 5, to which is arranged a rock drilling machine 6 that may be moved on the feed beam 5 by means of the feeding device 7. The rock drilling machine 6 may comprise a percussion device 8 for generating impact pulses on a tool 9 and a rotating device 10 for rotating the tool 9. Further, it may include a flushing device. The boom 3a shown in the figure and the drilling unit 4 arranged thereto are intended for drilling boreholes in a face 11 of a tunnel or a corresponding drilling site. Alternatively, the boom and the drilling unit thereon may be designed for drilling fan-like boreholes in a ceiling and walls of a rock cavern. Further, the rock drilling rig 1 comprises a boom 3b, which is provided with a bolting device 12, which also comprises a rock drilling machine 6. The rock drilling rig 1 may comprise a hydraulic system 13, which includes a hydraulic pump 34, hydraulic channels, a tank and necessary control means, such as valves and the like. The hydraulic system 13 may be a drilling hydraulic system, to which are connected actuators 15 necessary for moving the drilling booms 3a, 3b and a rock drilling machine 6. The rock drilling rig 1 also comprises one or more control units C, which is arranged to control the systems of the rock drilling rig 1. The control unit C may be a computer or a corresponding control device comprising a processor, a programmable logic or any other control device suitable for the purpose, to which it is possible to set at least one control strategy, according to which it carries out control independently or in cooperation with the operator.

At drilling site P one or more boreholes are drilled with the rock drilling rig 1. When the tasks assigned for the drilling site P are completed, the rock drilling rig 1 is transfer-driven away from the drilling site P to a new drilling site or somewhere else, for instance to be serviced. The rock drilling rig 1 is provided with drive equipment 16 which does not include a combustion engine, i.e. it is combustion-engine-free. Instead, the drive equipment 16 includes one or more electric engines M, which generate the power required in the transfer drive. The electric motor M may be coupled to a gearbox 17; wherefrom rotating power is transmitted through shafts or corresponding transmission elements 18 to one or more wheels 19. The energy required in transit drive may be charged to an energy storage B, which may be a battery, for instance. The drive equipment 16 may additionally include one or more control devices S and one or more brake resistors 20. The drive equipment 16 thus comprises a plurality of electric components K, which affect the transfer drive. These components K are loaded during transfer drive and they generate heat, the degree of which is relative to the electric energy passing through each component. As is commonly known, electric components have temperature limits that should not be exceeded, or otherwise a consequence could be a damaged component. In order to protect the components K, a rated load is generally determined for them, and normally they should be used at lower load than that. The control unit C may comprise load monitoring KV that is arranged to monitor the load in one or more components K included in the drive equipment 16 and connected to the electric driving system. By means of the load monitoring KV it is possible to avoid damaging of the electric driving system and other default and dangerous situations resulting from the load.

FIG. 1 also shows a speed controller 50, by which the operator may transmit a request on driving speed and power to the control unit C, which controls the electric driving system on the basis of the request transmitted. The speed controller 50 thus constitutes part of the user interface of the control unit C. The speed controller 50 may comprise a mechanical structure or it may be implemented as software on a display or in a corresponding manner.

Further, the rock drilling rig 1 may be provided with a liquid cooling system 21, by which it is possible to cool the electric components K included in the driving system 16, as will be described below.

FIG. 2 illustrates drive equipment 16, in which the electric motor M may be coupled through anti-slip power transmission path 22 directly to the gearbox 17, which may include one, two or more gears in the driving direction and correspondingly in the reverse direction. The rotating torque may be transmitted from the gearbox 17 to the wheel shafts 24 by means of shafts 23. Between the shafts 23 and 24 there may be an angle drive 25 or the like. In that case, between the wheels 19 and the electric motor M there is mechanical, anti-slip power transmission. The electric motor M may also be used for deceleration, and then it serves as a generator and converts kinetic energy of the carrier 2 to electric energy, for instance, when driving down the drive ramps in the mine. Generated electric energy may be charged into an energy storage B and thus recovered. Surplus electric energy, which cannot be utilized, may be converted to thermal energy in the brake resistor 20. The drive equipment 16 further includes a control device S, which may comprise a frequency converter, by which the rotation of the electric motor M may be controlled steplessly both during the drive and during the deceleration. The control device S may further comprise other necessary electric control devices for controlling electric currents in the electric driving system. The control device S may comprise, for instance, control means for coupling the energy storage B and the brake resistor 20 to the electric driving system. The operation of the control device S is controlled by the control unit C.

In this application the frequency converter refers to a control means, by which the revolving speed of the electric drive motor may be controlled in a stepless manner. The frequency converter may be an inverter or it may be a DC/AC converter, which controls the running of the electric motor.

In FIG. 2 there is depicted in broken lines yet another alternative application, in which the electric drive motor is coupled in anti-slip manner to the transmission means. In connection with the shaft 24 on the left there are wheel-specific electric hub motors M1, in connection wherewith there may be a required gearbox. Further, the rotating torque may be provided to the shaft 24 by means of one common electric drive motor M2.

The components K of the drive equipment 16 may be provided with temperature sensors L, and the information obtained therefrom may be conveyed to the control unit C and the load monitoring KV.

It appears from FIG. 2 that the control unit C may also control the operation of a liquid cooling system 21. The liquid cooling system 21 may comprise a plurality of cooling circuits 26a to 26d, to each of which is connected one or more electric components K of the drive equipment. The cooling circuits 26 may be provided with one or more valves or a corresponding control element 27, by which it is possible to affect the liquid flow in the cooling circuit 26. The control unit C may control these control elements 27 such that the cooling in accordance with the cooling strategy will be realized. It is further possible that a pump 28 of the liquid cooling system 21 is controlled, whereby the flow of the cooling liquid may be increased or reduced in the system. The control unit C may also control the operation of the cooling unit 29 such that the temperature of the cooling liquid may be affected. When necessary, it is possible to pre-cool the cooling liquid.

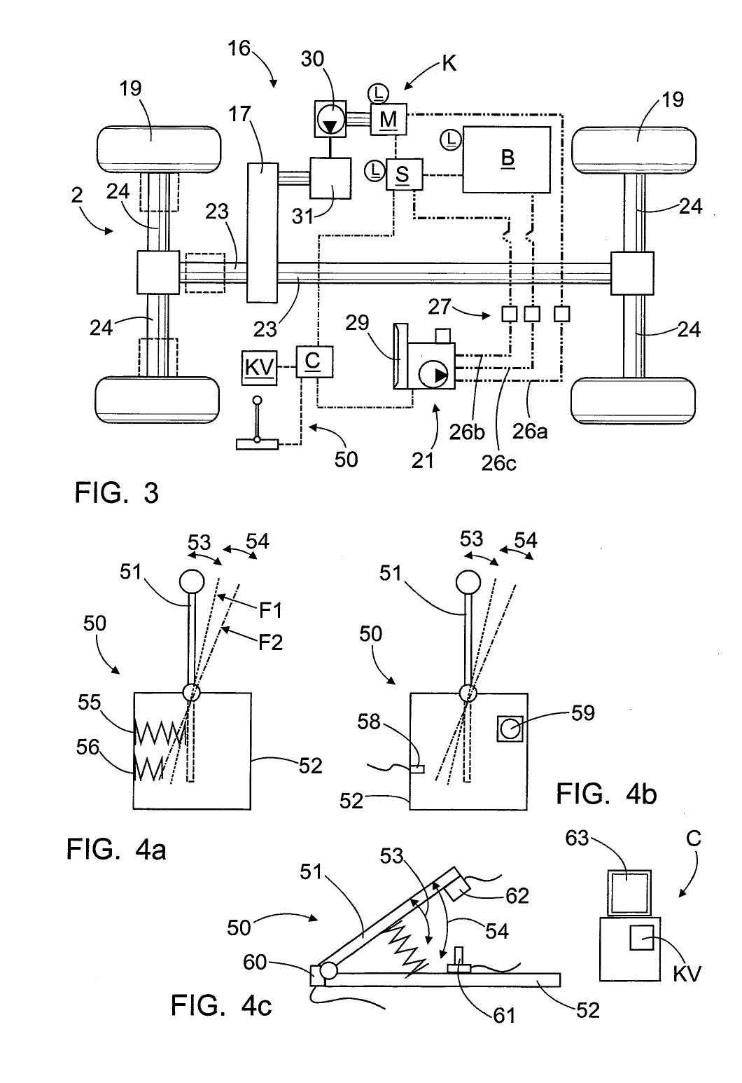

FIG. 3 shows an application of the drive equipment 16, where the electric motor M is arranged to run a hydraulic pump 30, and the generated hydraulic power drives a hydraulic motor 31 that is connected to the gearbox 17. Thus, hydraulic driving transmission is concerned. The electric motor M included in the drive equipment may be controlled by means of the control device S. The load in the components K of the drive equipment 16 may be monitored by means of load monitoring KV. FIG. 3 shows in broken lines hydraulic hub motors H1 alternative to the hydraulic motor 31 and the gearbox, and a hydraulic motor H2 driving the shaft 24.

FIGS. 4a to 4c show in a highly simplified manner some speed controllers 50 having a speed control element 51, by which the operator may transmit a request to the control unit C so as to affect the driving speed and performance.

In FIGS. 4a and 4c the speed control element 51 is a joystick that may be turned manually in relation to the frame 52. The speed control element 51 has a first control range 53 and a second control range 54. In the first control range 53 the speed controller 50 is arranged to control the drive equipment 16 such that the electric driving system and the components K coupled thereto are loaded without exceeding their rated load. After turning the speed control element 51 from the first control range 53 to the second control range 54, it is allowed to use higher powers and to exceed the rated load of the components K in the electric driving system.

FIG. 4a illustrates that the speed control element 51 may have different resistances of movement in the first control range 53 and the second control range 54. The resistance of movement of the speed control element 51 may be affected by spring members 55 and 56, or alternatively, it is possible to use an electric or pressure-medium-operated actuator so as to provide the resistance of movement. When the speed control element 51 is moved in the first control range 53, its movement is resisted only by the first spring member 55. When the speed control element 51 is moved more and transition to the second control range 54 takes place, the second spring member 56 starts affecting it as well. The second control range 54 has clearly higher resistance of movement F2 than the resistance of movement F1 in the first control range 53, and consequently the operator will not unintentionally move over to a control mode, where overload of components K is allowed.

In FIG. 4b the movement of the speed control element 51 is detected by means of a sensor 58, for instance. When there is a need in the control to transfer temporarily to the overload mode, the speed control element 51 is moved beyond the movement area of the first control range 53, which is detected by the sensor 58. Transition to the second control range 54 may be indicated by means of one or more indicators 59 to the operator. The indicator 59 may be an indicator light, for instance. Alternatively, the indicator 59 produces a sound signal. Thanks to the message or alarm produced by the indicator 59, the operator will not unintentionally move away from the first control range 53.

The speed controller 50 of FIG. 4c is a kind of accelerator pedal, in which power of the drive equipment or a component thereof is affected by pressing the speed control element 51. Position information on the speed control element 51 is obtained from a detector 60, from which the information is conveyed to the control unit C. When the speed control element 51 is moved for a longer travel with respect to the frame 52, a transition from the first control range 53 to the second control range 54 takes place, which may be detected by a limit switch 61, for instance. Detection information from the limit switch 61 is conveyed to the load monitoring KV, which allows the rated load of one or more components K coupled to the electric driving system to be exceeded and higher power used. The speed controller 50 may be provided with a vibration alarm 62, which indicates to the operator through vibration when transition to the overload area has taken place. It is also possible to display information on transition to the overload on a display device 63 included in the user interface of the control unit C. The display device 63 may also display other load monitoring KV information, such as duration of an overload situation and how long overloading may still be continued until the load monitoring forces the control to move back to the first control range. The display device 63 may also show temperatures of the components K and the increase in power and torque provided by overloading.

One optional speed controller application may be such that moving the speed control element 51 to the second control range 54 is possible only after selecting an overload mode by means of a switch or a display device.

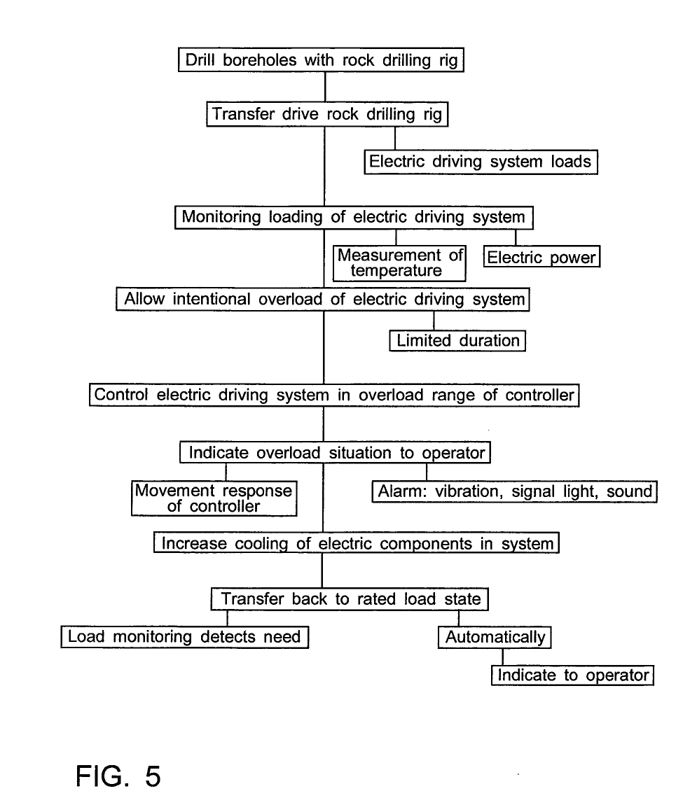

FIG. 5 shows, by means of a simple chart, details and control operations relating to transfer drive and load monitoring of drive equipment. After drilling, the rock drilling rig is moved away from the drilling location, i.e. it is transfer-driven. Thus, the drive equipment and its electric components are loaded. The control system and particularly the load monitoring included therein monitors the load of the electric driving system. The load monitoring may monitor the temperatures in the components, the use of the speed controller and electric power passing through each component in each particular driving situation. The transfer drive is to be performed such that the load of the electric driving system and the components coupled thereto will remain below the pre-determined rated load. During the drive there may be a need, however, to use the drive equipment at higher power than the rated load. The load monitoring comprises a control strategy, according to which it allows temporary overloading, i.e. the overload is of restricted duration. The speed controller may be arranged to have a separate control range, where overload is possible. In addition, the operator may be alarmed about transition to the overload state. Further, when transition to the overload mode takes place, cooling of the components in the system may be started by means of the cooling system. The cooling of particularly critical components may be prioritized. The load monitoring monitors the electric driving system and may transfer the automatic control from the overload mode back to the normal mode, if the predetermined, allowed duration ends, if the temperature in a component rises above an allowed limit, or if the load monitoring otherwise detects any one of the components to be at risk of getting damaged because of the overload. Alternatively, transition from the overload mode to the normal mode may take place manually through the operator. In that case the load monitoring may indicate to the operator that overloading is to be stopped. This may be performed through appropriate alarm devices.

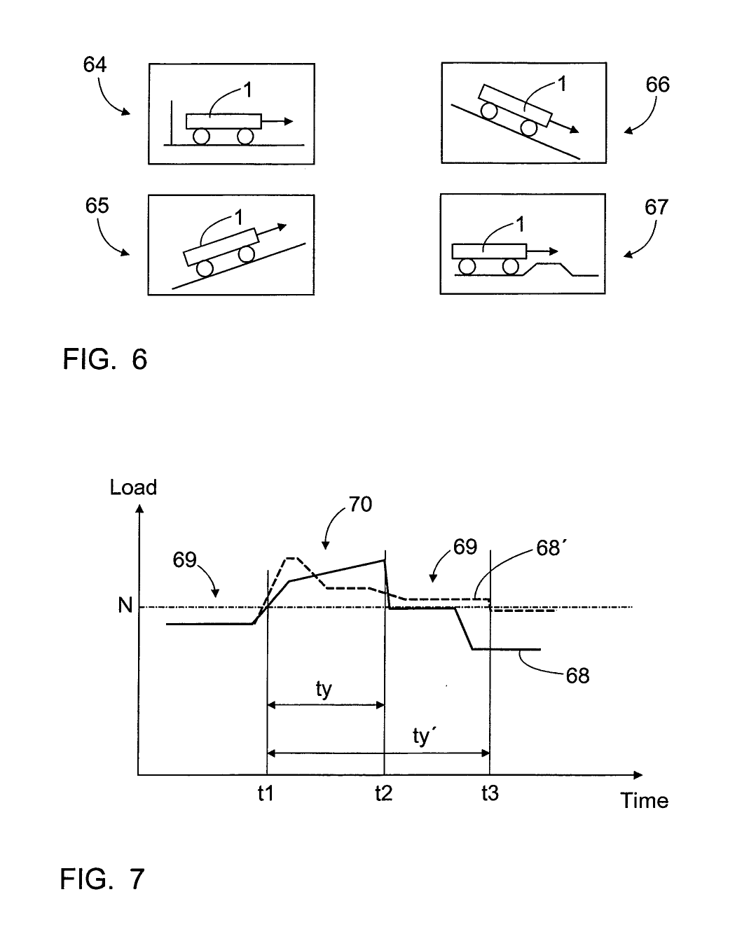

FIG. 6 shows some driving situations, in which it may be necessary to overload the electric driving system momentarily. The rock drilling rig 1 may be accelerated 64 by using higher power than normally. Uphill drive 65 may also necessitate use of higher power. In downhill drive 66 the rock drilling rig 1 may be decelerated by means of the drive equipment. In that case, at least some of the kinetic energy may be converted to electric energy and further to thermal energy in the brake resistor. The dynamics of the downhill drive is improved, if the components coupled to the electric driving system may be overloaded for a limited period of time. Yet another possible situation, in which overload may be needed, is driving over an obstacle 67. Of course the option for overload may also be applied in any other driving situations, in addition to those described above.

FIG. 7 shows a load curve 68 as a function of time. Normal driving situations 69 occur below a predetermined rated load N, and an over-load situation 70 appears above the limit N. The overload starts at time instant t1 and ends at instant t2 through load monitoring. In that case the load monitoring has allowed use of overload for a period of ty. Overload is temporary, and therefore it has a limited duration, which is generally determined on the basis of thermal power of the components. The duration is not necessarily predetermined, but the load monitoring may determine the allowed duration in view of the thermal resistance of the component, the driving task, the electric current to be conducted through the component, ambient conditions and other factors, if any. In FIG. 7, a broken line illustrates a second load curve 68′, which shows that by decreasing the overload gradually, the allowed duration ty′ becomes longer. The control unit may also have a control strategy that decreases the overload in a predetermined manner.

Even though the drive equipment of the rock drilling rig is completely without a combustion engine, the carrier of the rock drilling rig may comprise a reserve power unit, which may comprise a combustion engine. This combustion engine drives a generator for producing electric energy. The reserve power unit is not included, however, in the drive equipment, and it is only intended for use in special situations, for instance when the battery is flat or damaged.

In some cases, features disclosed in this application may be used as such, irrespective of other features. On the other hand, features disclosed in this application may, if required, be combined to form various combinations.

The drawings and the related description are only intended to illustrate the idea of the invention. Details of the invention may vary within the scope of the claims.

1. A rock drilling rig, comprising:
a movable carrier (2) having a plurality of wheels (19);
combustion-engine-free drive equipment (16) for performing transfer drive of the rock drilling rig (1), which drive equipment (16) comprises at least one electric motor (M) and an electric driving system as well as transmission members (17, 18) between the motor (M) and at least one traction wheel (19);
at least one boom (3a, 3b) movable relative to the carrier (2) and provided with at least one rock drilling machine (6);
at least one control unit (C) comprising load monitoring (KV) of the electric driving system and at least one control strategy; and
a user interface comprising at least one speed controller (50); characterized in that
the load monitoring (KV) is arranged to allow intentional overload of the electric driving system according to the predetermined control strategy;
the overload has a limited duration, when overheating of the components (K) in the electric driving system is prevented; and
the control unit (C) is arranged to indicate to the operator a transition from a rated load mode to an overload mode.

2. The rock drilling rig of claim 1, characterized in that
the electric driving system comprises at least some of the following electric components (K): a drive motor (M); an energy storage (B) for storing electric energy for transfer drive; a voltage converter; a frequency converter (S) whereby the drive motor (M) is controllable.

3. The rock drilling rig of claim 1 or 2, characterized in that
the load monitoring (KV) is arranged to allow overload of the electric driving system as the operator selects an overload mode in the user interface.

4. The rock drilling rig of any one of the preceding claims, characterized in that
the speed controller (50) comprises at least one first control range (53) and at least one second control range (54);
in the first control range (53) the electric driving system is loadable without exceeding the rated load of the components (K); and
the second control range (54) allows the rated load of the components (K) to be exceeded.

5. The rock drilling rig of any one of the preceding claims, characterized in that
the user interface of the control unit (C) is arranged to indicate to the operator the overload mode of the electric driving system having been selected; and
the user interface is additionally arranged to indicate to the operator at least one of the following load monitoring data: duration of overload situation; time left for overload situation; increase in power achieved by overload; increase in torque achieved by overload; temperature in the most critical component of the electric driving system.

6. The rock drilling rig of any one of the preceding claims, characterized in that
the rock drilling rig (1) comprises at least one cooling system (21) which is arranged to cool at least one electric component (K) of the electric driving system; and
the control unit (C) is arranged to increase the cooling of the at least one component (K) in response to an overload state.

7. The rock drilling rig of claim 1 or 2, characterized in that
the control unit (C) is arranged to control automatically momentary switching to an overload mode on the basis of a power request transmitted by the operator; and
the control unit (C) is arranged to indicate to the operator a transition from a rated load mode to an overload mode.

8. The rock drilling rig of any one of the preceding claims, characterized in that
the electric driving system comprises at least one temperature sensor (L) for monitoring the temperature of at least one critical component of the electric driving system; and
the temperature information is arranged for being conveyed to the load monitoring (KV), which considers the temperature information in the determination of the allowed duration of the overload state.

9. The rock drilling rig of any one of the preceding claims, characterized in that
the load monitoring (KV) is arranged to discontinue the overload state, when any one of the following predetermined limits has been reached: the maximum temperature set for the critical component; the maximum temperature set for any one of the components; the maximum duration calculated for the overload state.

10. The rock drilling rig of claim 9, characterized in that
the load monitoring (KV) is arranged to notify the operator in advance prior to discontinuation of the overload state.

11. A method for transfer drive of a rock drilling rig, the method comprising:
transfer driving the rock drilling rig (1) to a drilling site (P), where at least one borehole is drilled in rock with a drilling unit (4) included in the rock drilling rig;
employing for transfer drive combustion-engine-free drive equipment (16), in which the necessary rotational torque is provided by means of at least one electric motor (M); and
monitoring the load of the drive equipment (16) in the electric driving system in order for protecting the electric components (K) included therein; characterized by
overloading the electric driving system during the transfer drive intentionally and for a limited period of time; and
making the operator of the rock drilling rig aware of the overload situation.

12. The method of claim 11, characterized by
indicating the overload situation to the operator.

13. The method of claim 11 or 12, characterized by
allowing the overload situation only when accepted by the operator.

14. A method of any one of preceding claims 11 to 13, characterized by
allowing the overload of the electric driving system in one of the following transfer drive situations: drive over an obstacle; acceleration to base speed of transfer drive; steep uphill drive; drive over a pothole; drive onto a transportation platform; downhill drive of long duration.

15. A speed controller of an electric rock drilling rig, comprising:
at least one manual speed control element (51), which is movable by the operator in its first control range (53), which is designed on the basis of the rated load of the electric driving system of the rock drilling rig (1); characterized in that
the speed control element (51) comprises at least one other control range (54), where the control takes place in an overload portion exceeding the rated load.

16. The speed controller of claim 15, characterized in that
the speed control element (51) comprises in the second control range (54) a kinetic response (F2) that differs from the kinetic response (F1) of the first control range (53).

17. The speed controller of claim 15 or 16, characterized in that
the speed controller (50) comprises at least one indicator (59) which indicates transition to the second control range (54) in one of the following manners: a sound signal; a visual message; a vibration alarm.
